(19) United States
(12) Patent Application Publication
(10) Pub. No.: US 2026/0297716 A1
(43) Pub. Date: Oct. 1, 2026

(54) STEEL MATERIAL

(71) Applicant: NIPPON STEEL CORPORATION, Tokyo (JP)

(72) Inventors: Tomoaki HAMAGUCHI, Chiyoda-ku, Tokyo (JP); Satoru OKAWA, Chiyoda-ku, Tokyo (JP); Koji WATARI, Chiyoda-ku, Tokyo (JP); Kison NISHIHARA, Chiyoda-ku, Tokyo (JP)

(21) Appl. No.: 19/481,965

(22) PCT Filed: Jun. 9, 2023
(86) PCT No.: PCT/JP2023/021540

§ 371 Date: Nov. 6, 2025

(51) Int. Cl. C22C 38/44; C22C 38/00; C22C 38/02; C22C 38/04; C22C 38/06; C22C 38/42; C22C 38/46; C22C 38/48; C22C 38/50

(52) U.S. Cl. CPC C22C 38/44; C22C 38/001; C22C 38/02; C22C 38/04; C22C 38/06; C22C 38/42; C22C 38/46; C22C 38/48; C22C 38/50

(57) ABSTRACT

A steel material according to the present disclosure has a chemical composition consisting of, in mass %, C: 0.20 to 0.60%, Si: 0.05 to 1.00%, Mn: 0.20 to 1.00%, P: 0.030% or less, S: 0.0300% or less, Cr 5.60 to 7.00%, Mo: 1.00 to 4.00%, V: 0.10 to 1.50%, sol. Al: 0.0005 to 0.1000%, N: 0.0050 to 0.0500%, and the balance: Fe and impurities. In the steel material, a total area fraction of martensite and bainite is 99% or more, an average grain size of prior-austenite grains is 150 μm or less, a content of Cr contained in a residue extracted from the steel material by an electrolytic extraction method is 0.5 to 3.0% in mass %, and a content of Mo contained in the residue is 0.2 to 2.0% in mass %.

### TECHNICAL FIELD

The present disclosure relates to a steel material, and more particularly relates to a steel material which is suitable for use in high-temperature environments, as typified by a hot-working tool.

### BACKGROUND ART

When performing hot forging or hot extrusion, a hot-working tool such as a hot forging die or an extrusion tool is used. During hot working, a hot-working tool strikes against or comes into contact with a starting material which is at a high temperature of about 850 to 1300° C. Therefore, a steel material for use as a hot-working tool is required to have excellent strength in a high-temperature environment and also to have excellent toughness in a high-temperature environment. In the present description, the strength and toughness required in a high-temperature environment such as hot working are referred to as “high temperature strength” and “high temperature toughness”.

Techniques for improving the high temperature toughness of steel materials used as hot-working tools are proposed in International Application Publication No. WO2015/182586 (Patent Literature 1), International Application Publication No. WO2016/013273 (Patent Literature 2), and Japanese Patent Application Publication No. 2018-165400 (Patent Literature 3). In each of the steel materials disclosed in these Patent Literatures, the high temperature toughness is improved by refining the grains in the steel material.

### CITATION LIST

### Patent Literature

Patent Literature 1: International Application Publication No. WO2015/182586
Patent Literature 2: International Application Publication No. WO2016/013273
Patent Literature 3: Japanese Patent Application Publication No. 2018-165400

### Non Patent Literature

Non Patent Literature 1: Kengo Hata, “Three-dimensional EBSD Analysis and TEM Observation for Interface Microstructure during Reverse Phase Transformation in Low Carbon Steels” ISIJ International, vol. 58 (2018), No. 4, pp. 742 to 750

### SUMMARY OF INVENTION

### Technical Problem

However, in the case of the steel materials disclosed in Patent Literature 1 to Patent Literature 3, no consideration has been given to achieving both high temperature strength and high temperature toughness.

An objective of the present disclosure is to provide a steel material that has excellent high temperature strength and excellent high temperature toughness.

### Solution to Problem

A steel material according to the present disclosure is as follows.

A steel material having a chemical composition consisting of, in mass %,
C: 0.20 to 0.60%,
Si: 0.05 to 1.00%,
Mn: 0.20 to 1.00%,
P: 0.030% or less,
S: 0.0300% or less,
Cr: 5.60 to 7.00%,
Mo: 1.00 to 4.00%,
V: 0.10 to 1.50%,
sol. Al: 0.0005 to 0.1000%,
N: 0.0050 to 0.0500%,
Ni: 0 to 2.00%,
Cu: 0 to 0.050⁰/a,
Nb: 0 to 0.1000%,
Ti: 0 to 0.050%, and
the balance: Fe and impurities,
wherein:
a total area fraction of martensite and bainite is 99% or more,
an average grain size of prior-austenite grains is 150 μm or less,
a content of Cr contained in a residue extracted from the steel material by an electrolytic extraction method is, in mass %, 0.5 to 3.0%, and
a content of Mo contained in the residue is, in mass %, 0.2 to 2.0%.

### Advantageous Effects of Invention

The steel material of the present disclosure has excellent high temperature strength and excellent high temperature toughness.

### DESCRIPTION OF EMBODIMENTS

The present inventors conducted research and studies regarding a steel material that has excellent high temperature strength and excellent high temperature toughness. As a result, the present inventors obtained the following findings.

First, the present inventors conducted studies regarding a steel material that has excellent high temperature strength and excellent high temperature toughness, from the viewpoint of the chemical composition. As a result, the present inventors have considered that if a steel material has a chemical composition consisting of, in mass %, C: 0.20 to 0.60%, Si: 0.05 to 1.00%, Mn: 0.20 to 1.00%, P: 0.030% or less, S: 0.0300% or less, Cr: 5.60 to 7.00%, Mo: 1.00 to 4.00%, V: 0.10 to 1.50%, sol. Al: 0.0005 to 0.1000%, N: 0.0050 to 0.0500%, Ni: 0 to 2.00%, Cu: 0 to 0.050%, Nb: 0 to 0.1000%, Ti: 0 to 0.050%, and the balance: Fe and impurities, there is a possibility that excellent high temperature strength and excellent high temperature toughness can both be achieved. Therefore, with respect to a steel material having the chemical composition described above, the present inventors conducted further studies from the viewpoint of the microstructure with regard to means for obtaining excellent high temperature strength and obtaining excellent high temperature toughness.

In order to achieve high temperature toughness, it is effective to make the grains fine. Therefore, the present inventors conducted studies regarding a grain size that enables excellent high temperature toughness to be obtained in a steel material having the chemical composition described above. As a result, the present inventors have considered that if the average grain size of prior-austenite grains is 150 μm or less, it would be possible to achieve both excellent high temperature strength and excellent high temperature toughness.

However, it was revealed that even when steel materials had the chemical composition described above and the average grain size of prior-austenite grains was 150 μm or less, there were still cases where both excellent high temperature strength and excellent high temperature toughness could not be achieved.

Therefore, the present inventors conducted further studies directed at achieving both excellent high temperature strength and excellent high temperature toughness.

Here, the present inventors focused their attention on precipitates in the steel material. In a steel material having the chemical composition described above, multiple types of fine precipitates may be formed. The precipitates in the steel material increase the high temperature strength by precipitation strengthening. However, in some cases the precipitates become the starting points of cracks and reduce the high temperature toughness. Therefore, the present inventors have considered that if specific precipitates are formed in an appropriate amount, a reduction in high temperature toughness that is caused by precipitates acting as the starting points of cracks can be suppressed while also increasing the high temperature strength of the steel material.

In this connection, the size of precipitates that form in a steel material having the chemical composition described above is an extremely fine size which is at the nano level. For this reason it is difficult to quantitatively measure the number density of each type of precipitate using a scanning electron microscope or the like. However, when an electrolytic extraction method is used to analyze a steel material, and the chemical composition of an obtained extraction residue is determined, the precipitates in the steel material can be estimated.

Therefore, the present inventors analyzed steel materials having the chemical composition described above using an electrolytic extraction method, and investigated the relation between the components in the obtained residue, high temperature strength, and high temperature toughness. As a result, the present inventors have discovered that in a steel material having the chemical composition described above and in which the average grain size of prior-austenite grains is 150 μm or less, if the content of Cr obtained in the extraction residue is 0.5 to 3.0% in mass %, and the content of Mo obtained in the extraction residue is 0.2 to 2.0% in mass %, excellent high temperature strength and excellent high temperature toughness are obtained.

A steel material of the present embodiment, which has been completed based on the findings described above, is as follows.

[1]

A steel material having a chemical composition consisting of, in mass %,
C: 0.20 to 0.60%,
Si: 0.05 to 1.00%,
Mn: 0.20 to 1.00%,
P: 0.030% or less,
S: 0.0300% or less,
Cr: 5.60 to 7.00%,
Mo: 1.00 to 4.00%,
V: 0.10 to 1.50%,
sol. Al: 0.0005 to 0.1000%,
N: 0.0050 to 0.0500%,
Ni: 0 to 2.00%,
Cu: 0 to 0.050%,
Nb: 0 to 0.1000%,
Ti: 0 to 0.050%, and
the balance: Fe and impurities,
wherein:
a total area fraction of martensite and bainite is 99% or more,
an average grain size of prior-austenite grains is 150 μm or less,
a content of Cr contained in a residue extracted from the steel material by an electrolytic extraction method is, in mass %, 0.5 to 3.0%, and
a content of Mo contained in the residue is, in mass %, 0.2 to 2.0%.
   [2]

The steel material according to [1], wherein the chemical composition contains one or more elements selected from a group consisting of:
Ni: 0.01 to 2.00%,
Cu: 0.001 to 0.050%,
Nb: 0.0001 to 0.1000%, and
Ti: 0.001 to 0.050%.
   [3]

The steel material according to [1] or [2],
wherein the steel material is a hot-working tool.

Hereunder, the steel material of the present embodiment is described in detail. Note that, the symbol “%” in relation to elements means “mass %” unless otherwise stated.

### [Features of Steel Material of Present Embodiment]

The steel material of the present embodiment satisfies the following feature 1 to feature 4.

### (Feature 1)

The chemical composition consists of, in mass %, C: 0.20 to 0.60%, Si: 0.05 to 1.00%, Mn: 0.20 to 1.00%, P: 0.030% or less, S: 0.0300% or less, Cr: 5.60 to 7.00%, Mo: 1.00 to 4.00%, V: 0.10 to 1.50%, sol. Al: 0.0005 to 0.1000%, N: 0.0050 to 0.0500%, Ni: 0 to 2.00%, Cu: 0 to 0.050%, Nb: 0 to 0.1000%, Ti: 0 to 0.050%, and the balance: Fe and impurities.

### (Feature 2)

The total area fraction of martensite and bainite is 99% or more.

### (Feature 3)

The average grain size of prior-austenite grains is 150 μm or less.

### (Feature 4)

The content of Cr contained in a residue extracted from the steel material by an electrolytic extraction method is, in mass %, 0.5 to 3.0%, and the content of Mo contained in the residue is, in mass %, 0.2 to 2.0%.

Feature 1 to feature 4 are described hereunder.

### [(Feature 1) Regarding Chemical Composition]

The chemical composition of the steel material of the present embodiment contains the following elements.

### C: 0.20 to 0.60%

Carbon (C) increases hardenability of the steel material, and thereby increases the high temperature strength of the steel material. In addition, C forms carbides and/or carbo-nitrides and increases the high temperature strength of the steel material. C also stabilizes austenite. Specifically, C expands the temperature region in which austenite can stably exist and facilitates transformation into austenite by holding the temperature for a short period of time during reverse transformation. If the content of C is less than 0.20%, the aforementioned advantageous effects will not be sufficiently obtained even if the contents of other elements are within the range of the present embodiment.

On the other hand, if the content of C is more than 0.60%, even if the contents of other elements are within the range of the present embodiment, carbides will coarsen as a result of use of the steel material in a high-temperature environment. Consequently, the high temperature strength and high temperature toughness of the steel material will decrease.

Therefore, the content of C is 0.20 to 0.60%.

A preferable lower limit of the content of C is 0.25%, more preferably is 0.27%, and further preferably is 0.29%.

A preferable upper limit of the content of C is 0.55%, more preferably is 0.52%, and further preferably is 0.50%.

### Si: 0.05 to 1.00%

Silicon (Si) deoxidizes the steel. Si also increases machinability of the steel material. In addition, Si increases temper softening resistance and thereby increases the high temperature strength of the steel material. If the content of Si is less than 0.05%, the aforementioned advantageous effects will not be sufficiently obtained even if the contents of other elements are within the range of the present embodiment.

On the other hand, if the content of Si is more than 1.00%, coarse oxides will form even if the contents of other elements are within the range of the present embodiment. Consequently, the high temperature strength of the steel material will decrease, and the toughness of the steel material will decrease.

Therefore, the content of Si is 0.05 to 1.00%.

A preferable lower limit of the content of Si is 0.07%, more preferably is 0.08%, and further preferably is 0.09%.

A preferable upper limit of the content of Si is 0.90%, more preferably is 0.80%, further preferably is 0.70%, further preferably is 0.60%, and further preferably is 0.55%.

### Mn: 0.20 to 1.00%

Manganese (Mn) deoxidizes the steel. Mn also increases hardenability of the steel material and thereby increases the high temperature strength of the steel material. In addition, Mn stabilizes austenite. If the content of Mn is less than 0.20%, the aforementioned advantageous effects will not be sufficiently obtained even if the contents of other elements are within the range of the present embodiment.

On the other hand, if the content of Mn is more than 1.00%, even if the contents of other elements are within the range of the present embodiment, Mn in the steel material will segregate. Consequently, the high temperature strength of the steel material will decrease, and the high temperature toughness of the steel material will decrease.

Therefore, the content of Mn is 0.20 to 1.00%.

A preferable lower limit of the content of Mn is 0.22%, more preferably is 0.25%, further preferably is 0.27%, and further preferably is 0.30%.

A preferable upper limit of the content of Mn is 0.95%, more preferably is 0.90%, further preferably is 0.85%, further preferably is 0.80%, further preferably is 0.75%, and further preferably is 0.70%.

### P: 0.030% or Less

Phosphorus (P) is an impurity which is unavoidably contained, and hence the content of P is more than 0%. P segregates to grain boundaries. If the content of P is more than 0.030%, the hot workability, high temperature strength, and high temperature toughness of the steel material will decrease even if the contents of other elements are within the range of the present embodiment.

Therefore, the content of P is 0.030% or less.

The content of P is preferably as low as possible. However, extremely reducing the content of P will greatly increase the production cost. Therefore, when taking industrial production into consideration, a preferable lower limit of the content of P is 0.001%, more preferably is 0.003%, further preferably is 0.005%, and further preferably is 0.010%.

A preferable upper limit of the content of P is 0.028%, more preferably is 0.025%, further preferably is 0.023%, further preferably is 0.020%, and further preferably is 0.015%.

### S: 0.0300% or Less

Sulfur (S) is an impurity which is unavoidably contained, and hence the content of S is more than 0%. S may segregate to grain boundaries or form sulfides. If the content of S is more than 0.0300%, the hot workability, high temperature strength, and high temperature toughness of the steel material will decrease even if the contents of other elements are within the range of the present embodiment.

Therefore, the content of S is 0.0300% or less.

The content of S is preferably as low as possible. However, extremely reducing the content of S will greatly increase the production cost. Therefore, when taking industrial production into consideration, a preferable lower limit of the content of S is 0.0001%, more preferably is 0.0003%, and further preferably is 0.0005%.

A preferable upper limit of the content of S is 0.0250%, more preferably is 0.0200%, further preferably is 0.0150%, further preferably is 0.0100%, further preferably is 0.0090%, further preferably is 0.0070%, and further preferably is 0.0060%.

### Cr: 5.60 to 7.00%

Chromium (Cr) increases the hardenability of the steel material and thereby increases the high temperature strength of the steel material. Cr also increases temper softening resistance and increases the high temperature strength and high temperature toughness of the steel material. In addition, Cr forms carbides and increases the high temperature strength of the steel material. If the content of Cr is less than 5.60%, the aforementioned advantageous effects will not be sufficiently obtained even if the contents of other elements are within the range of the present embodiment.

On the other hand, if the content of Cr is more than 7.00%, the strength of the steel material will be too high even if the contents of other elements are within the range of the present embodiment. In such case, the high temperature toughness of the steel material will decrease.

Therefore, the content of Cr is 5.60 to 7.00%.

A preferable lower limit of the content of Cr is 5.63%, more preferably is 5.66%, and further preferably is 5.69%.

A preferable upper limit of the content of Cr is 6.97%, more preferably is 6.94%, and further preferably is 6.91%.

### Mo: 1.00 to 4.00%

Molybdenum (Mo) increases the high temperature strength of the steel material by solid-solution strengthening. In addition, Mo forms carbides and thereby increases the high temperature strength of the steel material and increases the high temperature toughness of the steel material. Mo also increases the wear resistance of the steel material. If the content of Mo is less than 1.00%, the aforementioned advantageous effects will not be sufficiently obtained even if the contents of other elements are within the range of the present embodiment.

On the other hand, if the content of Mo is more than 4.00%, the strength of the steel material will be too high even if the contents of other elements are within the range of the present embodiment. In such case, the machinability of the steel material may decrease or the high temperature toughness of the steel material may decrease.

Therefore, the content of Mo is 1.00 to 4.00%.

A preferable lower limit of the content of Mo is 1.10%, more preferably is 1.20%, further preferably is 1.30%, further preferably is 1.40%, and further preferably is 1.50%.

A preferable upper limit of the content of Mo is 3.90%, more preferably is 3.80%, and further preferably is 3.70%.

### V: 0.10 to 1.50%

Vanadium (V) increases the high temperature strength of the steel material by solid-solution strengthening. V also forms carbides and/or carbo-nitrides and increases the high temperature strength of the steel material. If the content of V is less than 0.10%, the aforementioned advantageous effect will not be sufficiently obtained even if the contents of other elements are within the range of the present embodiment.

On the other hand, if the content of V is more than 1.50%, even if the contents of other elements are within the range of the present embodiment, carbides and/or carbo-nitrides will coarsen as a result of use of the steel material in a high-temperature environment. Consequently, the high temperature strength and high temperature toughness of the steel material will decrease.

Therefore, the content of V is 0.10 to 1.50%.

A preferable lower limit of the content of V is 0.15%, more preferably is 0.20%, further preferably is 0.25%, further preferably is 0.30%, further preferably is 0.35%, and further preferably is 0.40%.

A preferable upper limit of the content of V is 1.45%, more preferably is 1.40%, further preferably is 1.30%, further preferably is 1.10%, and further preferably is 1.00%.

Sol. Al: 0.0005 to 0.1000%

Aluminum (Al) deoxidizes the steel. If the content of sol. Al is less than 0.0005%, the aforementioned advantageous effect will not be sufficiently obtained even if the contents of other elements are within the range of the present embodiment.

On the other hand, if the content of sol. Al is more than 0.1000%, oxides will excessively form. In such case, the high temperature strength and high temperature toughness of the steel material will decrease even if the contents of other elements are within the range of the present embodiment. In addition, the machinability of the steel material will decrease.

Therefore, the content of sol. Al is 0.0005 to 0.1000%.

A preferable lower limit of the content of sol. Al is 0.0010%, more preferably is 0.0015%, and further preferably is 0.0020%.

A preferable upper limit of the content of sol. Al is 0.0900%, more preferably is 0.0800%, further preferably is 0.0750%, further preferably is 0.0700%, further preferably is 0.0600%, further preferably is 0.0500%, and further preferably is 0.0400%.

In the present description, the term “content of Al” means the content of “acid-soluble Al”, that is, “sol. Al”.

### N: 0.0050 to 0.0500%

Nitrogen (N) forms nitrides and/or carbo-nitrides and thereby increases the high temperature strength of the steel material. In addition, N increases the high temperature strength of the steel material by solid-solution strengthening. N also stabilizes the structure of the steel material as an austenite stabilizing element. If the content of N is less than 0.0050%, the aforementioned advantageous effects will not be sufficiently obtained even if the contents of other elements are within the range of the present embodiment.

On the other hand, if the content of N is more than 0.0500%, even if the contents of other elements are within the range of the present embodiment, nitrides and/or carbo-nitrides will coarsen as a result of use of the steel material in a high-temperature environment. Consequently, the high temperature strength and high temperature toughness of the steel material will decrease.

Therefore, the content of N is 0.0050 to 0.0500%.

A preferable lower limit of the content of N is 0.0060%, more preferably is 0.0065%, and further preferably is 0.0070%.

A preferable upper limit of the content of N is 0.0400%, more preferably is 0.0380%, and further preferably is 0.0360%.

The balance of the chemical composition of the steel material according to the present embodiment is Fe and impurities. Here, the term “impurities” in the chemical composition refers to substances which are mixed in from ore or scrap as the raw material or from the production environment or the like when industrially producing the steel material, and which are permitted within a range that does not adversely affect the steel material according to the present embodiment.

### [Optional Elements]

The chemical composition of the steel material of the present embodiment may further contain one or more elements selected from a group consisting of:
Ni: 0 to 2.00%,
Cu: 0 to 0.050%,
Nb: 0 to 0.1000%, and
Ti: 0 to 0.050%.

These optional elements are described hereunder.

### [Regarding First Group: Ni and Cu]

The chemical composition of the steel material of the present embodiment may further contain one or more elements selected from a group consisting of Ni and Cu. Each of these elements is an optional element, and does not have to be contained. When contained, Ni and Cu contribute to the stabilization of austenite.

### Ni: 0 to 2.00%

Nickel (Ni) is an optional element, and does not have to be contained. That is, the content of Ni may be 0%.

When Ni is contained, that is, when the content of Ni is more than 0%, similarly to Mn, Ni contributes to the stabilization of austenite. If even a small amount of Ni is contained, the aforementioned advantageous effect will be obtained to a certain extent.

However, if the content of Ni is more than 2.00%, the transformation point will decrease even if the contents of other elements are within the range of the present embodiment. In such case, the high temperature strength of the steel material will decrease.

Therefore, the content of Ni is 0 to 2.00%.

A preferable lower limit of the content of Ni is 0.01%, more preferably is 0.03%, and further preferably is 0.05%.

A preferable upper limit of the content of Ni is 1.80%, more preferably is 1.60%, further preferably is 1.40%, and further preferably is 1.20%.

### Cu: 0 to 0.050%

Copper (Cu) is an optional element, and does not have to be contained. That is, the content of Cu may be 0%.

When Cu is contained, that is, when the content of Cu is more than 0%, Cu contributes to the stabilization of austenite. If even a small amount of Cu is contained, the aforementioned advantageous effect will be obtained to a certain extent.

However, if the content of Cu is more than 0.050%, the high temperature strength of the steel material will decrease even if the contents of other elements are within the range of the present embodiment.

Therefore, the content of Cu is 0 to 0.050%.

A preferable lower limit of the content of Cu is 0.001%, more preferably is 0.003%, further preferably is 0.005%, and further preferably is 0.008%.

A preferable upper limit of the content of Cu is 0.045%, more preferably is 0.040%, further preferably is 0.035%, and further preferably is 0.030%.

### [Regarding Second Group: Nb and Ti]

The chemical composition of the steel material of the present embodiment may further contain one or more elements selected from a group consisting of Nb and Ti. Each of these elements is an optional element, and does not have to be contained. When contained, Nb and Ti increase the high temperature strength of the steel material.

### Nb: 0 to 0.1000%

Niobium (Nb) is an optional element, and does not have to be contained. That is, the content of Nb may be 0%.

When Nb is contained, that is, when the content of Nb is more than 0%, Nb forms carbides and/or carbo-nitrides and thereby increases the high temperature strength of the steel material. If even a small amount of Nb is contained, the aforementioned advantageous effect will be obtained to a certain extent.

However, if the content of Nb is more than 0.1000%, even if the contents of other elements are within the range of the present embodiment, carbides and/or carbo-nitrides will coarsen as a result of use of the steel material in a high-temperature environment. Consequently, the high temperature strength and high temperature toughness of the steel material will decrease.

Therefore, the content of Nb is 0 to 0.1000%.

A preferable lower limit of the content of Nb is 0.0001%, more preferably is 0.0003%, further preferably is 0.0005%, and further preferably is 0.0010%.

A preferable upper limit of the content of Nb is 0.0800%, more preferably is 0.0600%, further preferably is 0.0550%, further preferably is 0.0400%, further preferably is 0.0300%, and further preferably is 0.0200%.

### Ti: 0 to 0.050%

Titanium (Ti) is an optional element, and does not have to be contained. That is, the content of Ti may be 0%.

When Ti is contained, that is, when the content of Ti is more than 0%, Ti forms carbides and/or carbo-nitrides and thereby increases the high temperature strength of the steel material. If even a small amount of Ti is contained, the aforementioned advantageous effect will be obtained to a certain extent.

However, if the content of Ti is more than 0.050%, even if the contents of other elements are within the range of the present embodiment, carbides and/or carbo-nitrides will coarsen as a result of use of the steel material in a high-temperature environment. Consequently, the high temperature strength and high temperature toughness of the steel material will decrease.

Therefore, the content of Ti is 0 to 0.050%.

A preferable lower limit of the content of Ti is 0.001%, more preferably is 0.002%, and further preferably is 0.003%.

A preferable upper limit of the content of Ti is 0.040%, more preferably is 0.030%, further preferably is 0.020%, and further preferably is 0.010%.

### [(Feature 2) Regarding Total Area Fraction of Martensite and Bainite]

In the microstructure of the steel material of the present embodiment, the total area fraction of martensite and bainite is 99% or more.

It is very difficult to distinguish between martensite and bainite in microstructure observation. On the other hand, ferrite can be distinguished very easily from martensite and bainite by contrast. Therefore, in microstructure observation, a region other than ferrite is recognized as “martensite and bainite”.

In the microstructure of the steel material of the present embodiment, if the total area fraction of martensite and bainite is less than 99%, ferrite will be formed in the balance of the microstructure. In such case, sufficient high temperature strength may not be obtained or sufficient high temperature toughness may not be obtained. On the other hand, if the total area fraction of martensite and bainite is 99% or more, excellent high temperature strength and excellent high temperature toughness will be obtained.

### [Method for Measuring Total Area Fraction of Martensite and Bainite]

The total area fraction of martensite and bainite in the microstructure of the steel material can be determined by the following method.

A test specimen is taken from a position at a depth of 1 mm or more from the surface of the steel material. Although not particularly limited, the size of the test specimen is, for example, 20 mm×15 mm×15 mm. A surface with dimensions of 20 mm×15 mm is adopted as an observation surface.

The observation surface of the test specimen is mirror polished. The observation surface after mirror-polishing is immersed for about 10 seconds in a nital etching reagent to reveal the microstructure by etching. The etched observation surface is observed using an optical microscope with a magnification of 500×. The visual field area of the observation field is to be set to 20,000 μm². As mentioned above, in the observation field, ferrite can be easily distinguished from martensite and bainite based on contrast. Therefore, the ferrite in the observation field is identified, and the area of the identified ferrite is determined. The area fraction (%) of ferrite is then determined by dividing the area of ferrite by the total area of the observation field. The decimals of the determined area fraction of ferrite are rounded off, and the resulting integer value is taken as the area fraction of ferrite.

The obtained area fraction of ferrite is used to determine the total area fraction (%) of martensite and bainite by the following formula.

Total area fraction (%) of martensite and bainite=100−area fraction of ferrite

### [(Feature 3) Regarding Average Grain Size of Prior-Austenite Grains]

In the steel material of the present embodiment, the average grain size of prior-austenite grains is 150 μm or less.

When the average grain size of prior-austenite grains is 150 μm or less, excellent high temperature strength and excellent high temperature toughness are obtained in the steel material.

A preferable upper limit of the average grain size of prior-austenite grains is 140 μm, more preferably is 130 μm, further preferably is 120 μm, further preferably is 110 μm, and further preferably is 100 μm.

The lower limit of the average grain size of prior-austenite grains is not particularly limited. A preferable lower limit of the average grain size of prior-austenite grains is 10 μm, more preferably is 15 μm, and further preferably is 20 μm.

### [Method for Determining Average Grain Size of Prior-Austenite Grains]

The average grain size (μm) of prior-austenite grains of the steel material according to the present embodiment is determined by the following method. First, a test specimen is taken from a position at a depth of 1 mm or more from the surface of the steel material. Although the size of the test specimen is not particularly limited, for example, a test specimen having a surface (observation surface) with dimensions of 10 mm×10 mm is taken.

The observation surface of the test specimen is mirror polished. Electron backscattering diffraction (EBSD) analysis described in Non Patent Literature 1 is performed on an arbitrary visual field region of 800 μm×800 μm on the observation surface to obtain crystal orientation information with respect to martensite and bainite. At such time, although the step size in the EBSD analysis is not particularly limited, for example, the step size is set to 1 μm. Grain boundaries of prior-austenite grains in the visual field region are identified based on the obtained crystal orientation information and the Kurdjumov-Sachs relationship. The equivalent circular diameter (μm) of each prior-austenite grain in the visual field region in which the grain boundaries of prior-austenite grains have been identified is determined. However, only prior-austenite grains which are entirely included within the visual field region are to be taken as the targets for determination of the equivalent circular diameter (μm). In addition, a prior-austenite grain identified as having an area of 1 μm² or less is regarded as an erroneous detection and is excluded from the targets for determination of the equivalent circular diameter (μm). Here, the term “equivalent circular diameter” means the diameter of a circle obtained in a case where the area of the relevant prior-austenite grain is converted to a circle having the same area. The arithmetic average value of the determined equivalent circular diameters of the respective prior-austenite grains is defined as the average grain size (μm) of prior-austenite grains. The decimals of the determined value are rounded off, and the resulting integer value is taken as the average grain size of prior-austenite grains.

### [(Feature 4) Regarding Content of Cr and Content of Mo in Extraction Residue]

In the steel material of the present embodiment, the content of Cr contained in a residue extracted from the steel material by an electrolytic extraction method is, in mass %, 0.5 to 3.0%, and the content of Mo contained in the residue is, in mass %, 0.2 to 2.0%.

In the steel material of the present embodiment, precipitates containing Cr and/or Mo are formed. Hereunder, precipitates containing Cr and/or Mo are referred to as “CrMo-containing precipitates”.

The CrMo-containing precipitates increase the high temperature strength of the steel material for use in a high-temperature environment. If the content of Cr in the residue is less than 0.5% or the content of Mo in the residue is less than 0.2%, the amount of CrMo-containing precipitates formed in the steel material is not sufficient. In this case, sufficient high temperature strength will not be obtained.

On the other hand, if the content of Cr in the residue is more than 3.0% or the content of Mo in the residue is more than 2.0%, CrMo-containing precipitates are formed excessively and are coarsened in the steel material. In this case, the strength within the prior-austenite grains in the steel material will be excessively high. As a result, sufficient high temperature toughness will not be obtained.

Therefore, the content of Cr contained in the residue is 0.5 to 3.0%, and the content of Mo contained in the residue is 0.2 to 2.0%.

A preferable lower limit of the content of Cr contained in the residue is 0.6%, more preferably is 0.7%, and further preferably is 0.8%.

A preferable upper limit of the content of Cr contained in the residue is 2.8%, more preferably is 2.6%, further preferably is 2.4%, and further preferably is 2.2%.

A preferable lower limit of the content of Mo contained in the residue is 0.3%, and more preferably is 0.4%.

A preferable upper limit of the content of Mo contained in the residue is 1.8%, more preferably is 1.6%, further preferably is 1.4%, and further preferably is 1.2%.

### [Method for Measuring Content of Cr and Content of Mo in Extraction Residue]

The content of Cr and the content of Mo contained in the extraction residue are determined by the following method.

A test specimen is taken from a position at a depth of 1 mm or more from the surface of the steel material. Although the size of the test specimen is not particularly limited, for example, the test specimen is a round bar specimen with a diameter of 15 mm and a length of 70 mm. The longitudinal direction of the round bar specimen is to be parallel with the surface of the steel material.

The taken test specimen is subjected to constant current electrolysis using a 10% AA-based solution (a solution containing, in volume fraction, 10% acetylacetone, 1% tetramethylammonium chloride, and 89% methanol solution). Specifically, the measurement is performed as follows.

First, pre-electrolysis is performed to remove deposits (scale and impurities on the surface) from the surface of the test specimen. In the pre-electrolysis, a region from the surface of the scale to a position at a depth of 100 μm is electrolyzed at normal temperature (15 to 30° C.) with a current of 1000 mA. After the pre-electrolysis, the test specimen is immersed in an alcohol solution. Ultrasonic cleaning is then performed to remove deposits from the surface of the test specimen. The mass of the test specimen from which the deposits have been removed, that is, the mass of the test specimen before constant current electrolysis is measured.

Next, the test specimen is subjected to constant current electrolysis. Specifically, a new 10% AA-based solution is prepared. Then, using the prepared new 10% AA-based solution, a region from the surface of the test specimen to a position at a depth of approximately 100 μm is electrolyzed at normal temperature while maintaining the current density at 30 mA/cm². Taking the specific gravity of the sample as being 7.8 g/cm³, the depth of the electrolyzed region is determined based on the difference (amount of decrease) in the mass (g) of the test specimen between before and after the constant current electrolysis, and the surface area of the test specimen. After the constant current electrolysis, the test specimen is immersed in an alcohol solution. Ultrasonic cleaning is then performed to remove deposits from the surface of the test specimen. The mass of the test specimen from which the deposits have been removed is measured, and the measured value is taken as the mass (g) of the test specimen after constant current electrolysis.

The 10% AA-based solution used in the constant current electrolysis, and the alcohol solution used in the ultrasonic cleaning thereafter are suction filtered through a filter with a mesh size of 0.2 μm to extract residue.

The extracted residue is subjected to chemical elemental analysis using Inductively Coupled Plasma Atomic Emission Spectrometry (ICP-AES). Specifically, the residue is dissolved in acid to obtain a solution. The solution is subjected to chemical elemental analysis using ICP-AES to obtain the Cr mass contained in the residue and the Mo mass contained in the residue. Based on the Cr mass (g) contained in the residue, and the difference (g) in the mass of the test specimen between before and after the constant current electrolysis, the content of Cr (mass %) contained in the residue is determined. Here, the difference in the mass of the test specimen between before and after the constant current electrolysis corresponds to the mass of the test specimen dissolved by the constant current electrolysis. In other words, the content of Cr contained in the residue means the content of Cr (mass %) contained in the residue in a case where the chemical composition of the steel material is taken as 100%.

Similarly, the content of Mo (mass %) contained in the residue is determined based on the Mo mass (g) contained in the residue, and the difference (g) in the mass of the test specimen between before and after the constant current electrolysis. In other words, the content of Mo contained in the residue means the content of Mo (mass %) contained in the residue in a case where the chemical composition of the steel material is taken as 100%.

The numerical values of the content of Cr (mass %) and the content of Mo (mass %) contained in the residue are to be rounded off to one decimal place.

### [Advantageous Effects of Steel Material of Present Embodiment]

The steel material of the present embodiment that satisfies the above feature 1 to feature 4 has excellent high temperature strength and excellent high temperature toughness.

### [Regarding High Temperature Strength Evaluation Method]

The high temperature strength of the steel material is measured by the following method.

A round bar tensile test specimen is taken from a position at a depth of 1 mm or more from the surface of the steel material. The diameter of the parallel portion of the round bar tensile test specimen is to be 6 mm, and the gage length is to be 30 mm. The longitudinal direction of the round bar tensile test specimen is to be parallel to the surface of the steel material. A high-temperature tensile test in accordance with JIS G 0567: 2020 is performed using the round bar tensile test specimen that is taken. Specifically, the round bar tensile test specimen is held for 10 minutes at 650° C. Thereafter, the round bar tensile test specimen at 650° C. is subjected to a tensile test at atmospheric pressure to determine the tensile strength (MPa). If the obtained tensile strength is 500 MPa or more, it is determined that the steel material has “excellent high temperature strength”.

### [Regarding High Temperature Toughness Evaluation Method]

The high temperature toughness of the steel material is evaluated by the following method.

A V-notch test specimen is taken from a position at a depth of 1 mm or more from the surface of the steel material. The size of the V-notch test specimen is to be 10 mm×10 mm×55 mm. The longitudinal direction of the V-notch test specimen is to be parallel to the surface of the steel material. Among the surfaces of the V-notch test specimen, a V-notch is to be formed at the center position of one surface that is parallel to the longitudinal direction. The V-notch is to be formed to a depth of 2 mm, with a V-notch angle of 45° and a V-notch tip radius R of 0.25 mm.

The V-notch test specimen is to be held for 30 minutes at 600° C. Thereafter, the V-notch test specimen at 600° C. is used to perform a Charpy impact test in accordance with JIS Z 2242: 2018 to determine the absorbed energy (J). If the obtained absorbed energy is 80 J or more, it is determined that the steel material has “excellent high temperature toughness”.

### [Applications of Steel Material]

The steel material of the present embodiment is widely applicable to applications in which the steel material is to be used in high-temperature environments where high temperature strength and high temperature toughness are required. The steel material of the present embodiment is suitable for use as a hot-working tool. Examples of hot-working tools include hot press dies, hot forging dies, die-casting dies, and hot extrusion tools.

### [Method for Producing Steel Material of Present Embodiment]

An example of a method for producing the steel material of the present embodiment will now be described. The method for producing the steel material described hereunder is one example for producing the steel material of the present embodiment. Accordingly, a steel material composed as described above may also be produced by a production method other than the production method described hereunder. However, the production method described hereunder is a preferable example of a method for producing the steel material of the present embodiment.

One example of a method for producing the steel material of the present embodiment includes the following processes.
(Process 1) Starting material preparation process
(Process 2) Hot working process
(Process 3) Quenching process
(Process 4) First tempering process
(Process 5) Second tempering process

The main production conditions in the above process 1 to process 5 are as follows.
(Condition 1) Quenching temperature T0 in process 3: 900 to 1100° C.
(Condition 2) Quenching time t0 in process 3: 0.5 to 7.0 hours
(Condition 3) Cooling rate CR0 in process 3: 0.10 to 1.00° C./sec
(Condition 4) Tempering temperature T1 in process 4: 500 to 550° C.
(Condition 5) Cooling rate CR1 in process 4: 0.10° C./sec or more
(Condition 6) Tempering temperature T2 in process 5: more than 550 to 650° C.
(Condition 7) Total of tempering time t1 in process 4 and tempering time t2 in process 5: 10.0 to 40.0 hours

Each process is described hereunder.

### [(Process 1) Starting Material Preparation Process]

In the starting material preparation process, a starting material having a chemical composition that satisfies feature 1 is prepared. Specifically, a molten steel in which the content of each element in the chemical composition satisfies feature 1 is prepared. The prepared molten steel is used to produce a starting material by a well-known casting process. For example, an ingot is produced by an ingot-making process. Alternatively, a bloom is produced by a continuous casting process. A starting material (ingot or bloom) is produced by the above process.

### [(Process 2) Hot Working Process]

In the hot working process, the starting material prepared in the starting material preparation process is subjected to hot working to form an intermediate steel material having the shape of the end product. The hot working is, for example, hot forging, hot rolling, or hot extrusion. The starting material is heated before the hot working. Although not particularly limited, the heating temperature is, for example, 1150 to 1300° C. Hot working may be performed multiple times.

### [(Process 3) Quenching Process]

In the quenching process, the intermediate steel material after hot working is subjected to quenching. The conditions in the quenching process are as follows.
(Condition 1) Quenching temperature T0 in process 3: 900 to 1100° C.
(Condition 2) Quenching time t0 in process 3: 0.5 to 7.0 hours
(Condition 3) Cooling rate CR0 in process 3: 0.10 to 1.00° C./sec

If the quenching temperature T0 is more than 1100° C., the average grain size of prior-austenite grains in the steel material will become too large and will be more than 150 μm. Therefore, the quenching temperature T0 is 1100° C. or less. Note that, it suffices that the lower limit of the quenching temperature T0 is the A_{C3} point or more, and for example is 900° C.

The holding time at the quenching temperature T0 is defined as the quenching time t0. If the quenching time t0 is more than 7.0 hours, austenite grains will coarsen. Consequently, the average grain size of prior-austenite grains in the steel material will become too large and will be more than 150 μm. Therefore, the quenching time t0 is 7.0 hours or less. Although not particularly limited, the lower limit of the quenching time t0 is, for example, 0.5 hours, and more preferably is 1.0 hour.

The cooling rate CR0 after holding at the quenching time t0 is 0.10 to 1.00° C./sec. The cooling rate CR0 is achieved by water cooling or oil cooling.

### [(Process 4) First Tempering Process]

In the method for producing the steel material of the present embodiment, tempering is performed twice (a first tempering process and a second tempering process). In the microstructure of the intermediate steel material after the quenching process, retained austenite is also present, and not only martensite. Therefore, in the first tempering process, retained austenite in the intermediate steel material is transformed to martensite. By transforming the retained austenite to martensite, in the second tempering process that is the next process, CrMo-containing precipitates can be formed uniformly throughout the whole microstructure.

The conditions in the first tempering process are as follows.
(Condition 4) Tempering temperature T1 in process 4: 500 to 550° C.
(Condition 5) Cooling rate CR1 in process 4: 0.10° C./sec or more

### [(Condition 4) Regarding Tempering Temperature T1]

If the tempering temperature T1 is less than 500° C., in some cases the transformation from retained austenite to martensite may be insufficient. In such case, the total area fraction of martensite and bainite will decrease. In addition, precipitates (Fe₂Mo) and the like other than CrMo-containing precipitates may form. In such case, the amount of CrMo-containing precipitates formed will be insufficient.

On the other hand, if the tempering temperature T1 is more than 550° C., although the transformation from retained austenite to martensite will be complete, formation of CrMo-containing precipitates will be promoted. Consequently, during the second tempering process, CrMo-containing precipitates will excessively form and will coarsen. Therefore, the content of Cr and/or the content of Mo in the residue will be too large.

### [(Condition 5) Regarding Cooling Rate CR1]

If the cooling rate CR1 after holding at the tempering temperature T1 is less than 0.10° C./sec, in some cases retained austenite may not transform to martensite during the course of cooling. In such case, the total area fraction of martensite and bainite will decrease. In addition, during the second tempering process, CrMo-containing precipitates will excessively form and will coarsen. Therefore, the content of Cr and/or content of Mo in the residue will be too large.

Although not particularly limited, the upper limit of the cooling rate CR1 is, for example, 1.00° C./sec.

### [(Process 5) Second Tempering Process]

In the second tempering process, CrMo-containing precipitates that satisfy feature 4 are formed. The conditions in the second tempering process are as follows.
(Condition 6) Tempering temperature T2 in process 5: more than 550 to 650° C.
(Condition 7) Total of tempering time t1 in process 4 and tempering time t2 in process 5: 10.0 to 40.0 hours

### [(Condition 6) Regarding Tempering Temperature T2]

If the tempering temperature T2 is more than 650° C., CrMo-containing precipitates will excessively form and will coarsen. In such case, sufficient high temperature toughness will not be obtained.

On the other hand, if the tempering temperature T2 is 550° C. or less, the amount of CrMo-containing precipitates formed will not be sufficient. In such case, sufficient high temperature strength will not be obtained.

Therefore, the tempering temperature T2 is more than 550 to 650° C.

[(Condition 7) Regarding Total of Tempering Time t1 and Tempering Time t2]

In addition, the holding time at the tempering temperature T1 in the first tempering process of process 4 is defined as a tempering time t1 (hours). Further, the holding time at the tempering temperature T2 in the second tempering process of process 5 is defined as a tempering time t2 (hours). In such case, if the total time of the tempering time t1 and the tempering time t2 is less than 10.0 hours, the tempering time will be too short. In such case, the amount of CrMo-containing precipitates formed will not be sufficient. Consequently, sufficient high temperature strength will not be obtained.

On the other hand, if the total time of the tempering time t1 and the tempering time t2 is more than 40.0 hours, the tempering time will be too long. In such case, CrMo-containing precipitates will excessively form and will coarsen.

Therefore, the total time of the tempering time t1 and the tempering time t2 is within the range of 10.0 to 40.0 hours.

A steel material that satisfies feature 1 to feature 4 can be produced by the production process described above.

The advantageous effects of the steel material of the present embodiment are described more specifically hereunder by way of examples. The conditions adopted in the following examples are one example of conditions adopted for confirming the feasibility and advantageous effects of the steel material of the present embodiment. Accordingly, the steel material of the present embodiment is not limited to this one example of conditions.

### EXAMPLES

Ingots having the chemical compositions shown in Table 1 were produced.

TABLE 1

| Test | Chemical Composition (unit is mass %; balance is Fe and impurities) | | | | | | | | | | | | | |
|---|---|---|---|---|---|---|---|---|---|---|---|---|---|---|
| Number | C | Si | Mn | P | S | Cr | Mo | V | sol. Al | N | Ni | Cu | Nb | Ti |
| 1 | 0.22 | 0.40 | 0.34 | 0.005 | 0.0021 | 5.81 | 2.10 | 0.51 | 0.0750 | 0.0182 | — | — | — | — |
| 2 | 0.59 | 0.64 | 0.48 | 0.008 | 0.0023 | 5.76 | 1.81 | 0.79 | 0.0643 | 0.0205 | — | — | — | — |
| 3 | 0.34 | 0.08 | 0.50 | 0.008 | 0.0020 | 6.13 | 1.55 | 1.12 | 0.0506 | 0.0270 | — | — | — | — |
| 4 | 0.42 | 0.94 | 0.60 | 0.003 | 0.0020 | 6.01 | 2.64 | 1.27 | 0.0120 | 0.0186 | — | — | — | — |
| 5 | 0.55 | 0.34 | 0.21 | 0.008 | 0.0027 | 5.95 | 3.11 | 0.62 | 0.0281 | 0.0213 | — | — | — | — |
| 6 | 0.32 | 0.29 | 0.96 | 0.012 | 0.0035 | 5.71 | 3.23 | 0.71 | 0.0243 | 0.0081 | — | — | — | — |
| 7 | 0.39 | 0.43 | 0.71 | 0.027 | 0.0210 | 6.17 | 2.21 | 0.52 | 0.0381 | 0.0090 | — | — | — | — |
| 8 | 0.28 | 0.84 | 0.43 | 0.020 | 0.0280 | 6.53 | 1.80 | 0.47 | 0.0213 | 0.0347 | — | — | — | — |
| 9 | 0.34 | 0.66 | 0.38 | 0.021 | 0.0035 | 5.61 | 1.97 | 0.43 | 0.0628 | 0.0223 | — | — | — | — |
| 10 | 0.33 | 0.39 | 0.30 | 0.009 | 0.0046 | 6.97 | 2.54 | 0.57 | 0.0030 | 0.0401 | — | — | — | — |
| 11 | 0.33 | 0.18 | 0.53 | 0.008 | 0.0022 | 6.77 | 1.06 | 0.55 | 0.0127 | 0.0286 | — | — | — | — |
| 12 | 0.51 | 0.24 | 0.59 | 0.008 | 0.0029 | 6.18 | 3.90 | 0.26 | 0.0021 | 0.0127 | — | — | — | — |
| 13 | 0.40 | 0.23 | 0.68 | 0.007 | 0.0013 | 6.08 | 2.68 | 0.12 | 0.0660 | 0.0104 | — | — | — | — |
| 14 | 0.43 | 0.48 | 0.81 | 0.010 | 0.0087 | 5.83 | 2.44 | 1.47 | 0.0519 | 0.0120 | — | — | — | — |
| 15 | 0.52 | 0.61 | 0.38 | 0.010 | 0.0101 | 5.91 | 2.18 | 1.28 | 0.0007 | 0.0208 | — | — | — | — |
| 16 | 0.36 | 0.70 | 0.44 | 0.010 | 0.0130 | 6.88 | 3.58 | 1.37 | 0.0930 | 0.0220 | — | — | — | — |
| 17 | 0.27 | 0.30 | 0.36 | 0.013 | 0.0067 | 6.29 | 3.40 | 0.80 | 0.0805 | 0.0055 | — | — | — | — |
| 18 | 0.26 | 0.56 | 0.55 | 0.014 | 0.0081 | 6.21 | 3.44 | 1.06 | 0.0350 | 0.0489 | — | — | — | — |
| 19 | 0.35 | 0.33 | 0.57 | 0.004 | 0.0034 | 5.86 | 2.49 | 0.54 | 0.0127 | 0.0220 | — | — | — | — |
| 20 | 0.33 | 0.35 | 0.53 | 0.004 | 0.0028 | 5.83 | 2.58 | 0.52 | 0.0035 | 0.0195 | — | — | — | — |
| 21 | 0.38 | 0.19 | 0.86 | 0.005 | 0.0050 | 6.04 | 1.80 | 0.79 | 0.0030 | 0.0230 | 0.12 | — | — | — |
| 22 | 0.41 | 0.43 | 0.59 | 0.018 | 0.0047 | 5.87 | 2.91 | 0.67 | 0.0039 | 0.0231 | — | — | 0.0510 | — |
| 23 | 0.36 | 0.55 | 0.60 | 0.013 | 0.0111 | 5.90 | 2.57 | 0.55 | 0.0047 | 0.0244 | — | — | — | 0.023 |
| 24 | 0.30 | 0.19 | 0.47 | 0.015 | 0.0092 | 6.27 | 3.71 | 0.52 | 0.0082 | 0.0192 | — | 0.018 | — | — |
| 25 | 0.54 | 0.22 | 0.46 | 0.014 | 0.0067 | 6.30 | 3.49 | 0.49 | 0.0138 | 0.0183 | 0.53 | 0.038 | — | 0.041 |
| 26 | 0.43 | 0.28 | 0.38 | 0.024 | 0.0051 | 6.05 | 3.22 | 0.71 | 0.0190 | 0.0188 | 0.27 | — | 0.0270 | 0.010 |
| 27 | 0.69 | 0.35 | 0.61 | 0.020 | 0.0023 | 5.88 | 3.07 | 0.39 | 0.0131 | 0.0337 | — | — | — | — |
| 28 | 0.44 | 0.42 | 0.52 | 0.001 | 0.0010 | 9.12 | 2.10 | 0.55 | 0.0200 | 0.0320 | 0.05 | 0.012 | 0.0010 | — |
| 29 | 0.34 | 0.33 | 0.59 | 0.001 | 0.0010 | 5.90 | 6.80 | 0.88 | 0.0110 | 0.0300 | — | — | 0.0200 | 0.003 |
| 30 | 0.43 | 0.39 | 0.58 | 0.018 | 0.0037 | 5.38 | 2.80 | 0.54 | 0.0228 | 0.0415 | — | — | — | — |
| 31 | 0.52 | 0.61 | 0.38 | 0.010 | 0.0101 | 5.91 | 2.18 | 1.28 | 0.0007 | 0.0208 | — | — | — | — |
| 32 | 0.36 | 0.70 | 0.44 | 0.010 | 0.0130 | 6.88 | 3.58 | 1.37 | 0.0930 | 0.0220 | — | — | — | — |
| 33 | 0.27 | 0.30 | 0.36 | 0.013 | 0.0067 | 6.29 | 3.40 | 0.80 | 0.0805 | 0.0055 | — | — | — | — |
| 34 | 0.26 | 0.56 | 0.55 | 0.014 | 0.0081 | 6.21 | 3.44 | 1.06 | 0.0350 | 0.0489 | — | — | — | — |
| 35 | 0.35 | 0.33 | 0.57 | 0.004 | 0.0034 | 5.86 | 2.49 | 0.54 | 0.0127 | 0.0220 | — | — | — | — |
| 36 | 0.33 | 0.35 | 0.53 | 0.004 | 0.0028 | 5.83 | 2.58 | 0.52 | 0.0035 | 0.0195 | — | — | — | — |
| 37 | 0.38 | 0.19 | 0.86 | 0.005 | 0.0050 | 6.04 | 1.80 | 0.79 | 0.0030 | 0.0230 | 0.12 | — | — | — |
| 38 | 0.22 | 0.40 | 0.34 | 0.005 | 0.0021 | 5.81 | 2.10 | 0.51 | 0.0750 | 0.0182 | — | — | — | — |
| 39 | 0.59 | 0.64 | 0.48 | 0.008 | 0.0023 | 5.76 | 1.81 | 0.79 | 0.0643 | 0.0205 | — | — | — | — |
| 40 | 0.34 | 0.08 | 0.50 | 0.008 | 0.0020 | 6.13 | 1.55 | 1.12 | 0.0506 | 0.0270 | — | — | — | — |
| 41 | 0.42 | 0.94 | 0.60 | 0.003 | 0.0020 | 6.01 | 2.64 | 1.27 | 0.0120 | 0.0186 | — | — | — | — |
| 42 | 0.55 | 0.34 | 0.21 | 0.008 | 0.0027 | 5.95 | 3.11 | 0.62 | 0.0281 | 0.0213 | — | — | — | — |
| 43 | 0.32 | 0.29 | 0.96 | 0.012 | 0.0035 | 5.71 | 3.23 | 0.71 | 0.0243 | 0.0081 | — | — | — | — |
| 44 | 0.39 | 0.43 | 0.71 | 0.027 | 0.0210 | 6.17 | 2.21 | 0.52 | 0.0381 | 0.0090 | — | — | — | — |
| 45 | 0.28 | 0.84 | 0.43 | 0.020 | 0.0280 | 6.53 | 1.80 | 0.47 | 0.0213 | 0.0347 | — | — | — | — |
| 46 | 0.34 | 0.66 | 0.38 | 0.021 | 0.0035 | 5.61 | 1.97 | 0.43 | 0.0628 | 0.0223 | — | — | — | — |
| 47 | 0.33 | 0.39 | 0.30 | 0.009 | 0.0046 | 6.97 | 2.54 | 0.57 | 0.0030 | 0.0401 | — | — | — | — |
| 48 | 0.33 | 0.18 | 0.53 | 0.008 | 0.0022 | 6.77 | 1.06 | 0.55 | 0.0127 | 0.0286 | — | — | — | — |

Each of the produced ingots was subjected to hot forging to produce an intermediate steel material having a rectangular parallelepiped shape. The heating temperature of the ingot during hot forging was 1150 to 1300° C. The intermediate steel material was subjected to a quenching process. The quenching temperature T0 (° C.), quenching time t0 (hrs), and cooling rate CR0 (° C./sec) in the quenching process were as shown in Table 2.

TABLE 2

| | Quenching Process | | | First Tempering Process | | | Second Tempering | | |
|---|---|---|---|---|---|---|---|---|---|
| | | | Cooling | | | Cooling | Process | | Total |
| | | | Rate | | | Rate | Temper- | | Tem- |
| Test | Temper- | Time | CR0 | Temper- | Time | CR1 | ature | Time | pering |
| Num- | ature | t0 | (° C./ | ature | t1 | (° C./ | T2 | t2 | Time |
| ber | T0 (° C.) | (hrs) | sec) | T1 (° C.) | (hrs) | sec) | (° C.) | (hrs) | (hrs) |
| 1 | 1000 | 3.0 | 0.30 | 520 | 10.0 | 0.30 | 600 | 20.0 | 30.0 |
| 2 | 1000 | 3.0 | 0.30 | 520 | 10.0 | 0.30 | 600 | 20.0 | 30.0 |
| 3 | 1000 | 5.0 | 0.50 | 520 | 10.0 | 0.30 | 600 | 20.0 | 30.0 |
| 4 | 1000 | 5.0 | 0.50 | 520 | 10.0 | 0.30 | 620 | 20.0 | 30.0 |
| 5 | 950 | 3.0 | 0.80 | 520 | 10.0 | 0.30 | 620 | 20.0 | 30.0 |
| 6 | 950 | 5.0 | 0.80 | 520 | 15.0 | 0.30 | 620 | 20.0 | 35.0 |
| 7 | 1000 | 1.0 | 0.50 | 500 | 15.0 | 0.20 | 620 | 20.0 | 35.0 |
| 8 | 1000 | 3.0 | 0.50 | 500 | 15.0 | 0.20 | 650 | 20.0 | 35.0 |
| 9 | 1050 | 1.0 | 0.50 | 550 | 15.0 | 0.50 | 650 | 20.0 | 35.0 |
| 10 | 1050 | 3.0 | 0.30 | 550 | 15.0 | 0.50 | 650 | 15.0 | 30.0 |
| 11 | 1000 | 1.0 | 0.80 | 550 | 15.0 | 0.50 | 600 | 15.0 | 30.0 |
| 12 | 1000 | 3.0 | 1.00 | 550 | 15.0 | 0.50 | 600 | 15.0 | 30.0 |
| 13 | 1100 | 0.5 | 0.80 | 530 | 10.0 | 0.50 | 600 | 15.0 | 25.0 |
| 14 | 1100 | 1.0 | 1.00 | 530 | 10.0 | 0.50 | 560 | 15.0 | 25.0 |
| 15 | 1000 | 0.5 | 0.50 | 530 | 10.0 | 1.00 | 560 | 15.0 | 25.0 |
| 16 | 1000 | 1.0 | 0.30 | 520 | 10.0 | 1.00 | 560 | 10.0 | 20.0 |
| 17 | 900 | 5.0 | 0.50 | 520 | 10.0 | 1.00 | 580 | 10.0 | 20.0 |
| 18 | 900 | 5.0 | 0.50 | 520 | 10.0 | 1.00 | 580 | 10.0 | 20.0 |
| 19 | 950 | 5.0 | 0.30 | 520 | 10.0 | 0.80 | 580 | 10.0 | 20.0 |
| 20 | 950 | 5.0 | 0.30 | 550 | 10.0 | 0.80 | 570 | 10.0 | 20.0 |
| 21 | 1000 | 6.0 | 1.00 | 550 | 5.0 | 0.80 | 570 | 10.0 | 15.0 |
| 22 | 1000 | 6.0 | 0.50 | 550 | 5.0 | 0.50 | 570 | 20.0 | 25.0 |
| 23 | 1000 | 7.0 | 0.50 | 550 | 5.0 | 0.50 | 600 | 20.0 | 25.0 |
| 24 | 1050 | 3.0 | 0.80 | 500 | 3.0 | 0.50 | 600 | 20.0 | 23.0 |
| 25 | 1050 | 3.0 | 0.80 | 500 | 3.0 | 0.50 | 600 | 10.0 | 13.0 |
| 26 | 950 | 5.0 | 0.50 | 510 | 3.0 | 0.50 | 650 | 10.0 | 13.0 |
| 27 | 950 | 5.0 | 0.50 | 510 | 5.0 | 0.50 | 650 | 10.0 | 15.0 |
| 28 | 950 | 5.0 | 0.50 | 540 | 5.0 | 0.50 | 570 | 10.0 | 15.0 |
| 29 | 1000 | 3.0 | 1.00 | 540 | 10.0 | 0.80 | 570 | 10.0 | 20.0 |
| 30 | 1000 | 5.0 | 0.80 | 540 | 10.0 | 0.80 | 570 | 20.0 | 30.0 |
| 31 | 1150 | 3.0 | 0.50 | 530 | 10.0 | 0.80 | 600 | 25.0 | 35.0 |
| 32 | 1200 | 3.0 | 0.50 | 530 | 10.0 | 0.30 | 570 | 15.0 | 25.0 |
| 33 | 1000 | 8.0 | 0.50 | 520 | 10.0 | 0.80 | 650 | 30.0 | 40.0 |
| 34 | 1000 | 10.0 | 0.50 | 530 | 10.0 | 0.30 | 650 | 30.0 | 40.0 |
| 35 | 900 | 5.0 | 0.10 | 480 | 10.0 | 0.80 | 650 | 30.0 | 40.0 |
| 36 | 900 | 5.0 | 0.20 | 450 | 10.0 | 0.30 | 650 | 15.0 | 25.0 |
| 37 | 1050 | 3.0 | 0.50 | 600 | 10.0 | 1.00 | 570 | 15.0 | 25.0 |
| 38 | 1050 | 3.0 | 0.50 | 580 | 20.0 | 0.50 | 570 | 20.0 | 40.0 |
| 39 | 1050 | 5.0 | 0.50 | 520 | 20.0 | 0.05 | 570 | 10.0 | 30.0 |
| 40 | 1050 | 6.0 | 0.50 | 520 | 20.0 | 0.01 | 570 | 10.0 | 30.0 |
| 41 | 1050 | 7.0 | 0.50 | 520 | 20.0 | 0.50 | 500 | 10.0 | 30.0 |
| 42 | 950 | 3.0 | 0.50 | 520 | 20.0 | 0.50 | 520 | 10.0 | 30.0 |
| 43 | 950 | 5.0 | 0.80 | 530 | 20.0 | 0.50 | 680 | 10.0 | 30.0 |
| 44 | 950 | 7.0 | 0.80 | 530 | 20.0 | 0.50 | 700 | 10.0 | 30.0 |
| 45 | 950 | 5.0 | 0.80 | 530 | 3.0 | 1.00 | 600 | 5.0 | 8.0 |
| 46 | 1000 | 0.5 | 0.80 | 540 | 3.0 | 1.00 | 600 | 3.0 | 6.0 |
| 47 | 1000 | 1.0 | 0.50 | 540 | 20.0 | 1.00 | 620 | 30.0 | 50.0 |
| 48 | 1000 | 2.0 | 0.50 | 540 | 20.0 | 1.00 | 620 | 40.0 | 60.0 |

The intermediate steel material after the quenching process was subjected to a first tempering process. The tempering temperature T1 (° C.), tempering time t1 (hrs), and cooling rate CR1 (° C./sec) in the first tempering process were as shown in Table 2.

The intermediate steel material after the first tempering process was subjected to a second tempering process. The tempering temperature T2 (° C.) and tempering time t2 (hrs) in the second tempering process were as shown in Table 2. A steel material of each test number was produced by the above production process.

### [Evaluation Tests]

The steel material of each test number was subjected to the following evaluation tests.
(Test 1) Test to measure total area fraction of martensite and bainite
(Test 2) Test to measure average grain size of prior-austenite grains
(Test 3) Test to measure content of Cr and content of Mo in extraction residue
(Test 4) High temperature strength evaluation test
(Test 5) High temperature toughness evaluation test

Each evaluation test is described hereunder.

### [(Test 1) Test to Measure Total Area Fraction of Martensite and Bainite]

The total area fraction (%) of martensite and bainite in the steel material of each test number was determined by the method described above in the section [Method for measuring total area fraction of martensite and bainite]. Note that, a test specimen was taken from a position at a depth of 1 mm or more from the surface of the steel material. The size of the test specimen was 20 mm×15 mm×15 mm, and a surface of 20 mm×15 mm was adopted as the observation surface. The determined total area fraction of martensite and bainite is shown in the column “M+B Total Area Fraction (%)” in Table 3.

TABLE 3

| | M + B Total | | | | High | High | |
|---|---|---|---|---|---|---|---|
| | Area | Average | Cr | Mo | Temperature | Temperature | |
| Test | Fraction | Grain Size | Content | Content | Tensile | Absorbed | |
| Number | (%) | (μm) | (mass %) | (mass %) | Strength (MPa) | Energy (J) | Remarks |
| 1 | 99 | 101 | 0.8 | 0.4 | 517 | 157 | Inventive Example |
| 2 | 99 | 121 | 2.7 | 1.8 | 597 | 91 | Inventive Example |
| 3 | 100 | 143 | 2.2 | 1.6 | 583 | 101 | Inventive Example |
| 4 | 100 | 130 | 2.2 | 1.8 | 571 | 90 | Inventive Example |
| 5 | 100 | 75 | 2.3 | 1.7 | 583 | 85 | Inventive Example |
| 6 | 100 | 89 | 2.0 | 1.4 | 566 | 108 | Inventive Example |
| 7 | 100 | 105 | 1.5 | 0.8 | 564 | 120 | Inventive Example |
| 8 | 100 | 89 | 1.9 | 1.0 | 547 | 128 | Inventive Example |
| 9 | 100 | 138 | 0.6 | 1.5 | 538 | 167 | Inventive Example |
| 10 | 100 | 147 | 2.9 | 0.8 | 576 | 119 | Inventive Example |
| 11 | 100 | 105 | 2.5 | 0.3 | 549 | 108 | Inventive Example |
| 12 | 100 | 118 | 2.0 | 1.9 | 576 | 93 | Inventive Example |
| 13 | 100 | 141 | 2.3 | 1.7 | 591 | 105 | Inventive Example |
| 14 | 100 | 130 | 1.9 | 1.3 | 556 | 117 | Inventive Example |
| 15 | 100 | 83 | 1.8 | 1.3 | 580 | 106 | Inventive Example |
| 16 | 100 | 108 | 2.5 | 1.8 | 621 | 83 | Inventive Example |
| 17 | 100 | 53 | 2.5 | 1.7 | 620 | 86 | Inventive Example |
| 18 | 99 | 64 | 1.8 | 0.6 | 551 | 124 | Inventive Example |
| 19 | 100 | 51 | 1.7 | 0.7 | 566 | 116 | Inventive Example |
| 20 | 99 | 67 | 2.3 | 1.7 | 601 | 86 | Inventive Example |
| 21 | 100 | 124 | 1.9 | 0.7 | 546 | 127 | Inventive Example |
| 22 | 100 | 120 | 2.2 | 1.8 | 588 | 94 | Inventive Example |
| 23 | 100 | 123 | 2.3 | 1.8 | 573 | 99 | Inventive Example |
| 24 | 100 | 141 | 2.2 | 1.6 | 569 | 108 | Inventive Example |
| 25 | 100 | 129 | 1.6 | 0.8 | 559 | 148 | Inventive Example |
| 26 | 100 | 84 | 1.1 | 0.4 | 536 | 123 | Inventive Example |
| 27 | 100 | 77 | 2.7 | 1.7 | 477 | 53 | Comparative Example |
| 28 | 100 | 60 | 4.1 | 1.0 | 643 | 40 | Comparative Example |
| 29 | 100 | 90 | 2.3 | 2.5 | 682 | 62 | Comparative Example |
| 30 | 100 | 93 | 0.6 | 0.2 | 425 | 51 | Comparative Example |
| 31 | 100 | 168 | 2.6 | 1.9 | 487 | 33 | Comparative Example |
| 32 | 100 | 189 | 1.8 | 1.0 | 446 | 57 | Comparative Example |
| 33 | 100 | 188 | 2.2 | 1.7 | 479 | 66 | Comparative Example |
| 34 | 100 | 206 | 0.8 | 0.3 | 433 | 58 | Comparative Example |
| 35 | 95 | 33 | 0.3 | 0.1 | 459 | 72 | Comparative Example |
| 36 | 97 | 37 | 0.2 | 0.1 | 447 | 62 | Comparative Example |
| 37 | 100 | 127 | 3.2 | 2.3 | 527 | 56 | Comparative Example |
| 38 | 100 | 140 | 3.2 | 2.5 | 621 | 48 | Comparative Example |
| 39 | 98 | 135 | 4.1 | 3.1 | 630 | 70 | Comparative Example |
| 40 | 97 | 130 | 5.6 | 3.3 | 644 | 13 | Comparative Example |
| 41 | 100 | 148 | 0.3 | 0.1 | 477 | 172 | Comparative Example |
| 42 | 100 | 66 | 0.4 | 0.1 | 483 | 153 | Comparative Example |
| 43 | 100 | 58 | 3.1 | 2.5 | 637 | 43 | Comparative Example |
| 44 | 100 | 80 | 3.3 | 2.4 | 620 | 58 | Comparative Example |
| 45 | 100 | 56 | 0.4 | 0.1 | 471 | 160 | Comparative Example |
| 46 | 100 | 87 | 0.3 | 0.1 | 480 | 150 | Comparative Example |
| 47 | 100 | 68 | 3.5 | 2.7 | 628 | 33 | Comparative Example |
| 48 | 100 | 86 | 3.8 | 3.0 | 601 | 17 | Comparative Example |

### [(Test 2) Test to Measure Average Grain Size of Prior-Austenite Grains]

The average grain size (μm) of prior-austenite grains in the steel material of each test number was determined by the method described above in the section [Method for determining average grain size of prior-austenite grains]. Note that, a test specimen was taken from a position at a depth of 1 mm or more from the surface of the steel material of each test number. The test specimen had a surface of 10 mm×10 mm. The surface of 10 mm×10 mm was adopted as an observation surface. Further, the step size in the EBSD analysis was set to 1 μm. The determined average grain size of prior-austenite grains is shown in the column “Average Grain Size (μm)” in Table 3.

### [(Test 3) Test to Measure Content of Cr and Content of Mo in Extraction Residue]

The content of Cr (mass %) and content of Mo (mass %) in an extraction residue of the steel material of each test number were determined by the method described above in the section [Method for measuring content of Cr and content of Mo in extraction residue]. Note that, a test specimen was taken from a position at a depth of 1 mm or more from the surface of the steel material. The test specimen was a round bar specimen with a diameter of 15 mm and a length of 70 mm. The determined content of Cr (mass %) and content of Mo (mass %) in the extraction residue are shown in the column “Cr Content (mass %)” and the column “Mo Content (mass %)” in Table 3.

### [(Test 4) High Temperature Strength Evaluation Test]

The tensile strength (MPa) at 650° C. of the steel material of each test number was determined by the method described above in the section [Regarding high temperature strength evaluation method]. Note that, a round bar tensile test specimen was taken from a position at a depth of 1 mm or more from the surface of the steel material. The diameter of the parallel portion of the round bar tensile test specimen was 6 mm, and the gage length was 30 mm. The determined tensile strength is shown in the column “High Temperature Tensile Strength (MPa)” in Table 3.

### [(Test 5) High Temperature Toughness Evaluation Test]

The absorbed energy (J) at 600° C. of the steel material of each test number was determined by the method described above in the section [Regarding high temperature toughness evaluation method]. Note that, a V-notch test specimen was taken from a position at a depth of 1 mm or more from the surface of the steel material. The size of the V-notch test specimen was 10 mm×10 mm×55 mm. The determined absorbed energy is shown in the column “High Temperature Absorbed Energy (J)” in Table 3.

### [Evaluation Results]

Referring to Table 1, Table 2, and Table 3, the steel materials of Test Nos. 1 to 26 satisfied feature 1 to feature 4. Therefore, the tensile strength at 650° C. was 500 MPa or more and thus excellent high temperature strength was obtained. In addition, the absorbed energy at 600° C. was 80 J or more and thus excellent high temperature toughness was obtained.

On the other hand, in Test No. 27 the content of C was too high. Consequently, the tensile strength at 650° C. was less than 500 MPa and thus excellent high temperature strength was not obtained. In addition, the absorbed energy at 600° C. was less than 80 J and thus excellent high temperature toughness was not obtained.

In Test No. 28, the content of Cr was too high. Consequently, the content of Cr contained in the extraction residue was too high. Therefore, the absorbed energy at 600° C. was less than 80 J and thus excellent high temperature toughness was not obtained.

In Test No. 29, the content of Mo was too high. Consequently, the content of Mo contained in the extraction residue was too high. Therefore, the absorbed energy at 600° C. was less than 80 J and thus excellent high temperature toughness was not obtained.

In Test No. 30, the content of Cr was too low. Consequently, the tensile strength at 650° C. was less than 500 MPa and thus excellent high temperature strength was not obtained. In addition, the absorbed energy at 600° C. was less than 80 J and thus excellent high temperature toughness was not obtained.

In Test Nos. 31 and 32, the quenching temperature T0 was too high. Consequently, the average grain size of prior-austenite grains was more than 150 μm. Therefore, the tensile strength at 650° C. was less than 500 MPa and thus excellent high temperature strength was not obtained. In addition, the absorbed energy at 600° C. was less than 80 J and thus excellent high temperature toughness was not obtained.

In Test Nos. 33 and 34, the quenching time t0 was too long. Consequently, the average grain size of prior-austenite grains was more than 150 μm. Therefore, the tensile strength at 650° C. was less than 500 MPa and thus excellent high temperature strength was not obtained. In addition, the absorbed energy at 600° C. was less than 80 J and thus excellent high temperature toughness was not obtained.

In Test Nos. 35 and 36, the tempering temperature T1 in the first tempering process was too low. Consequently, the total area fraction of martensite and bainite was low. In addition, the content of Cr and the content of Mo contained in the extraction residue were too low. Therefore, the tensile strength at 650° C. was less than 500 MPa and thus excellent high temperature strength was not obtained. In addition, the absorbed energy at 600° C. was less than 80 J and thus excellent high temperature toughness was not obtained.

In Test Nos. 37 and 38, the tempering temperature T1 in the first tempering process was too high. Consequently, the content of Cr and the content of Mo contained in the extraction residue were too high. Therefore, the absorbed energy at 600° C. was less than 80 J and thus excellent high temperature toughness was not obtained.

In Test Nos. 39 and 40, because air cooling was performed as the cooling in the first tempering process, the cooling rate CR1 was too slow. Consequently, the total area fraction of martensite and bainite was less than 99%, and the content of Cr and content of Mo contained in the extraction residue were too high. Therefore, the absorbed energy at 600° C. was less than 80 J and thus excellent high temperature toughness was not obtained.

In Test Nos. 41 and 42, the tempering temperature T2 in the second tempering process was too low. Consequently, the content of Cr and content of Mo contained in the extraction residue were too low. Therefore, the tensile strength at 650° C. was less than 500 MPa and thus excellent high temperature strength was not obtained.

In Test Nos. 43 and 44, the tempering temperature T2 in the second tempering process was too high. Consequently, the content of Cr and content of Mo contained in the extraction residue were too high. Therefore, the absorbed energy at 600° C. was less than 80 J and thus excellent high temperature toughness was not obtained.

In Test Nos. 45 and 46, the total time (t1+t2) of the tempering in the first tempering process and the second tempering process was too short. Consequently, the content of Cr and content of Mo in the extraction residue were too low. Therefore, the tensile strength at 650° C. was less than 500 MPa and thus excellent high temperature strength was not obtained.

In Test Nos. 47 and 48, the total time (t1+t2) of the tempering in the first tempering process and the second tempering process was too long. Consequently, the content of Cr and content of Mo contained in the extraction residue were too high. Therefore, the absorbed energy at 600° C. was less than 80 J and thus excellent high temperature toughness was not obtained.

An embodiment of the present disclosure has been described above. However, the embodiment described above is merely an example for carrying out the present disclosure. Therefore, the present disclosure is not limited to the above-described embodiment, and can be implemented by appropriately modifying the above-described embodiment within a range not departing from the gist thereof.

1. A steel material having a chemical composition consisting of, in mass %,
C: 0.20 to 0.60%,
Si: 0.05 to 1.00%,
Mn: 0.20 to 1.00%,
P: 0.030% or less,
S: 0.0300% or less,
Cr: 5.60 to 7.00%,
Mo: 1.00 to 4.00%,
V: 0.10 to 1.50%,
sol. Al: 0.0005 to 0.1000%,
N: 0.0050 to 0.0500%,
Ni: 0 to 2.00%,
Cu: 0 to 0.050%,
Nb: 0 to 0.1000%,
Ti: 0 to 0.050%, and
the balance: Fe and impurities,
wherein:
a total area fraction of martensite and bainite is 99% or more,
an average grain size of prior-austenite grains is 150 μm or less,
a content of Cr contained in a residue extracted from the steel material by an electrolytic extraction method is, in mass %, 0.5 to 3.0%, and
a content of Mo contained in the residue is, in mass %, 0.2 to 2.0%.

2. The steel material according to claim 1, wherein the chemical composition contains one or more elements selected from a group consisting of:
Ni: 0.01 to 2.00%,
Cu: 0.001 to 0.050%,
Nb: 0.0001 to 0.1000%, and
Ti: 0.001 to 0.050%.

3. The steel material according to claim 1, wherein:
the steel material is a hot-working tool.

4. The steel material according to claim 2, wherein:
the steel material is a hot-working tool.
